(19) United States
(12) Patent Application Publication
(10) Pub. No.: US 2011/0149286 A1
(43) Pub. Date: Jun. 23, 2011

(54) LIQUID CORE WAVEGUIDE ASSEMBLY AND DETECTING SYSTEM INCLUDING THE SAME

(76) Inventors: Chih-Wei Wu, Keelung (TW); Ting-I Wu, Keelung (TW); Wei-Han Chen, Keelung (TW)

(21) Appl. No.: 12/642,640

(22) Filed: Dec. 18, 2009

(51) Int. Cl. G01N 21/00; G02B 6/032; G02B 6/10

(52) U.S. Cl. 356/436; 385/125; 385/147; 385/12

(57) ABSTRACT

A liquid core waveguide assembly includes: a waveguide-forming body formed with a waveguide channel and first and second fiber channels, transparent first and second partition walls, and a liquid inlet in fluid communication with the waveguide channel, the waveguide channel having a first end spaced apart from the first fiber channel by the first partition wall, and a second end spaced apart from the second fiber channel by the second partition wall; and at least one first optical fiber and at least one second optical fiber extending into the first and second fiber channels, respectively. A detecting system including the liquid core waveguide assembly is also disclosed.

### BACKGROUND OF THE INVENTION

1. Field of the Invention

The invention relates to a liquid core waveguide assembly and a detecting system including the same, more particularly to a liquid core waveguide assembly including a waveguide-forming body and optical fibers extending into the waveguide-forming body.

2. Description of the Related Art

Referring to FIGS. 1 and 2, a published paper by Wu et at., “Fabrication of PDMS-based Nitrite Sensors Using Teflon AF Coating Microchannels”, IEEE Sensors Journal, Vol. 8, No. 5, May 2008, discloses a conventional detecting system for detecting the concentration of slats, such as nitrites, silicates, and phosphates, in a solution. The conventional detecting system includes a PDMS-based waveguide chip 11, a halogen lamp 12, a spectrometer 13, two commercial optical fiber cables 14 with Subminiature Version A (SMA) connectors 141 connected to the halogen lamp 12 and the spectrometer 13, respectively, and a position-aligning working table 15. The waveguide chip 11 has a channel-defining wall coated with a Teflon layer 111 that defines a waveguide channel 112 for receiving a liquid sample 16 therein. The Teflon layer 111 has a refractive index considerably less than that of the liquid sample 16, thereby permitting total internal reflection to take place in the waveguide channel 112 when light passes through the liquid sample 16 in the waveguide channel 112. The liquid sample 16 normally contains a solution with ions of interest and reagents that are reactive with the ions for developing a color in the solution for spectrometric analysis. In operation, the waveguide chip 11 is placed on the position-aligning working table 15, the latter is then adjusted to align two ends of the waveguide channel 112 with two adjacent ones of the SMA connectors 141 of the optical fiber cables 14, respectively, along a longitudinal direction of the waveguide channel 112, and the halogen lamp 12 is then turned on to emit a light beam that passes through one of the optical fiber cables 14 and the liquid sample 16 in the waveguide channel 112 and is received by the spectrometer 13 through the other of the optical fiber cables 14. The intensity of the light beam is analyzed by the spectrometer 13 so as to determine the concentration of the ions in the solution. The whole disclosure of the aforesaid published paper is incorporated herein by reference.

Since the intensity of the light beam thus measured is significantly affected by the position of the waveguide chip 11 relative to the two adjacent ones of the SMA connectors 141 of the optical fiber cables 14, the conventional detecting system has a poor repeatability and is subject to human or experimental errors in determining the concentration of the ions in the solution. Moreover, adjustment of the position-aligning working table 15 to align the waveguide chip 11 with the adjacent SMA connectors 141 of the optical fiber cables 14 is laborious and time consuming, and the inclusion of the halogen lamp 12, the spectrometer 13 and the position-aligning working table 15 in the conventional detecting system makes it difficult for the conventional detecting system to be portable.

### SUMMARY OF THE INVENTION

Therefore, an object of the present invention is to provide a liquid core waveguide assembly that can overcome the aforesaid drawbacks associated with the prior art.

Another object of the present invention is to provide a portable detecting system including the liquid core waveguide assembly.

Accordingly, an embodiment of a liquid core waveguide assembly of the present invention comprises: a waveguide-forming body formed with at least one waveguide channel and first and second fiber channels therein and having transparent first and second partition walls and a liquid inlet in fluid communication with the waveguide channel and allowing for injection of a liquid sample into the waveguide channel therethrough, the waveguide channel having a first end disposed adjacent to the first fiber channel and spaced apart from the first fiber channel by the first partition wall, and a second end opposite to the first end, disposed adjacent to the second fiber channel, and spaced apart from the second fiber channel by the second partition wall; and at least one first optical fiber and at least one second optical fiber extending into the first and second fiber channels, respectively.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view illustrating the configuration of a conventional detecting system;

FIG. 2 is a sectional view illustrating how the position of a waveguide chip is adjusted by operating an adjustable working table to align the waveguide chip with a SMA connector of an optical fiber cable of the conventional detecting system;

FIG. 3 is a schematic view of an embodiment of a portable detecting system according to this invention;

FIG. 4 is a perspective view of a liquid core waveguide assembly of the embodiment of FIG. 3;

FIG. 5 is a sectional view taken along line V-V in FIG. 4;

FIG. 6 is an exploded perspective view of the embodiment of FIG. 3;

FIG. 7 is a schematic view of another embodiment of a detecting system; and

FIG. 8 is a schematic view of another embodiment of a detecting system.

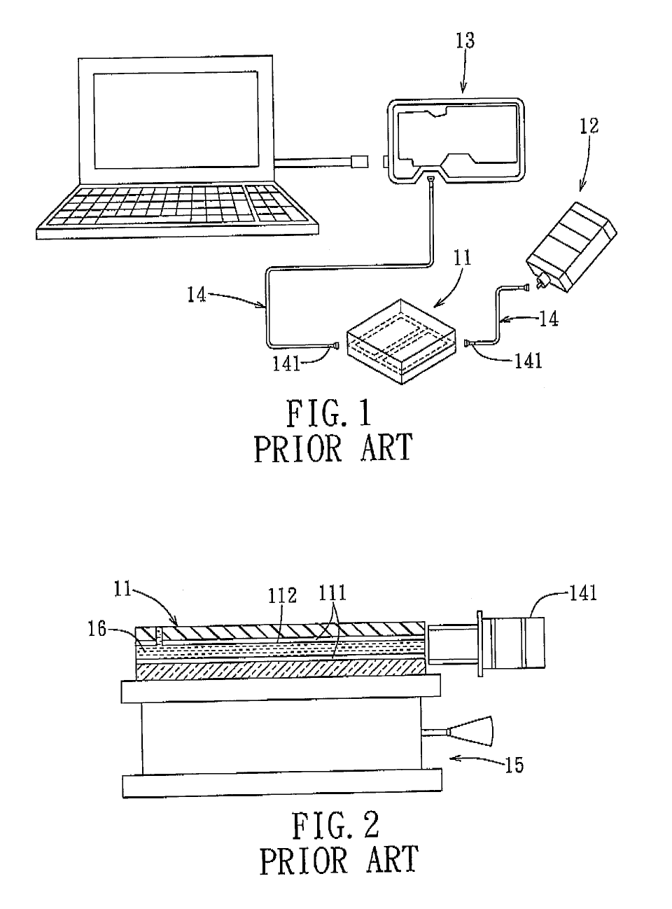

### DETAILED DESCRIPTION

Before the present invention is described in greater detail with reference to the accompanying preferred embodiments, it should be noted herein that like elements are denoted by the same reference numerals throughout the disclosure.

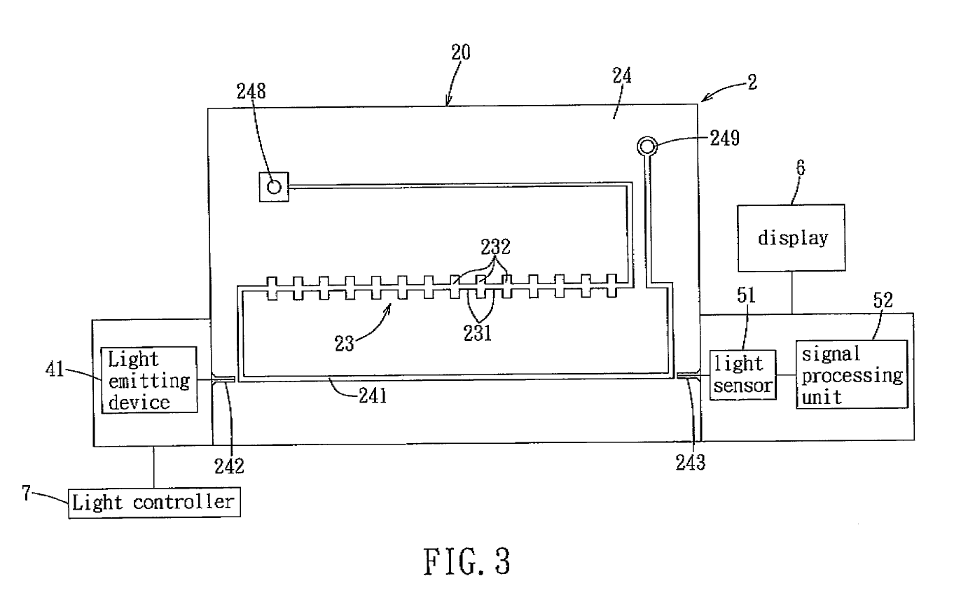

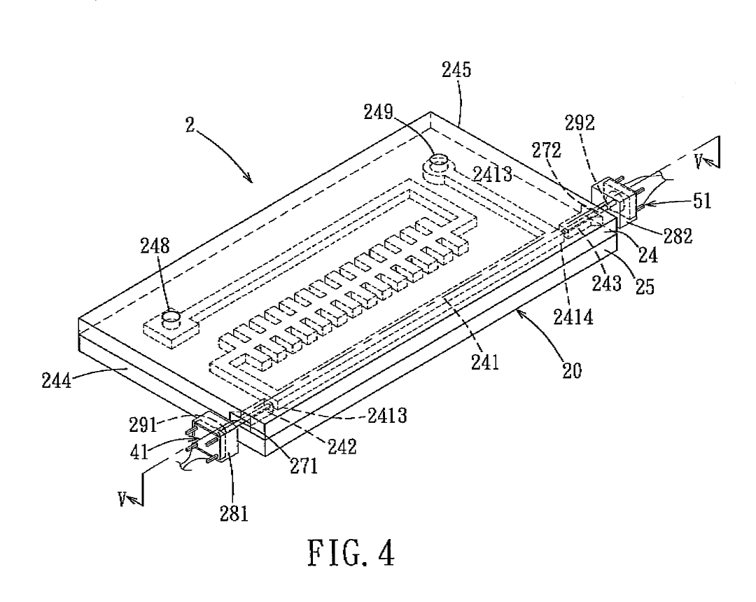

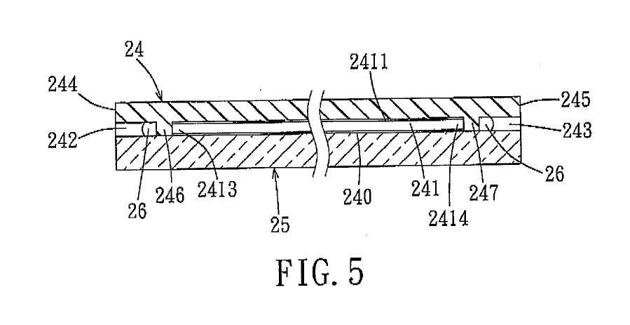

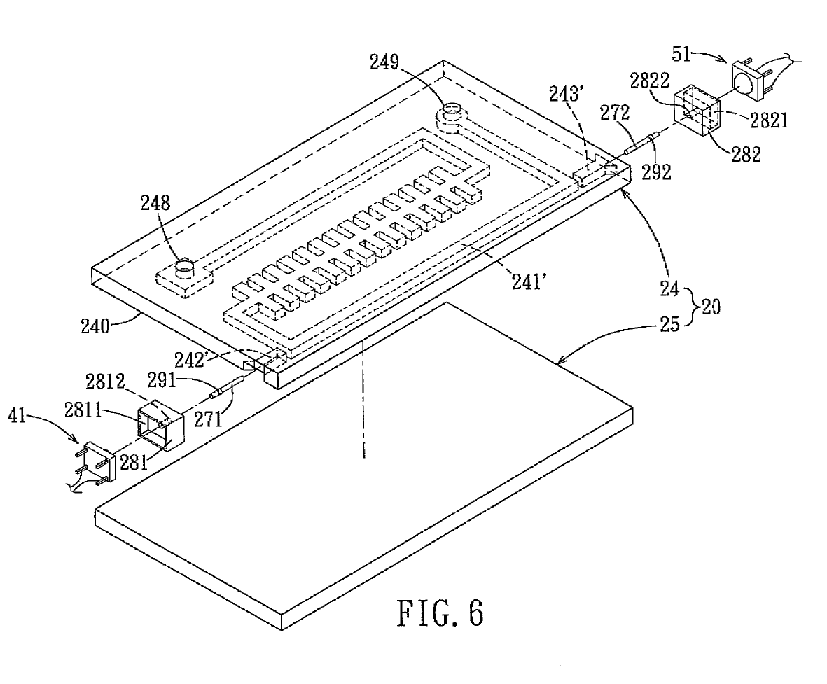

Referring to FIGS. 3 to 6, an embodiment of a portable detecting system includes a liquid core waveguide assembly 2, a light emitting device 41, a light sensor 51, a signal processing unit 52, a display 6, and a light controller 7.

The liquid core waveguide assembly 2 includes a waveguide-forming body 20, a first optical fiber 271, a second optical fiber 272, first and second caps 281, 282, and first and second elastic sleeves 291, 292. In another embodiment, the liquid core waveguide assembly 2 includes a plurality of first optical fibers 271 and a plurality of second optical fibers 272 so as to transmit sufficient light from the light emitting device 41 for facilitating detection of the light sensor 51.

The waveguide-forming body 20 is formed with a waveguide channel 241 and first and second fiber channels 242, 243 therein, and has opposite first and second side surfaces 244, 245, transparent first and second partition walls 246, 247, a liquid inlet 248 in fluid communication with the waveguide channel 241 and allowing for injection of a liquid sample (not shown) into the waveguide channel 241 therethrough, and a liquid outlet 249 in fluid communication with the waveguide channel 241 and allowing for discharging of the liquid sample therethrough. The waveguide channel 241 has a first end 2413 disposed adjacent to the first fiber channel 242 and spaced apart from the first fiber channel 242 by the first partition wall 246, and a second end 2414 disposed adjacent to the second fiber channel 243 and spaced apart from the second fiber channel 243 by the second partition wall 247. The first and second ends 2413, 2414 of the waveguide channel 241 are opposite to each other along a longitudinal direction of the waveguide channel 241. The first fiber channel 242 extends from the first side surface 244 of the waveguide-forming body 20 toward the waveguide channel 241. The second fiber channel 243 extends from the second side surface 245 of the waveguide-forming body 20 toward the waveguide channel 241.

The first and second optical fibers 271, 272 extend into the first and second fiber channels 242, 243, respectively, for transmitting a light beam generated from the light emitting device 41 from the first optical fiber 271 through the waveguide channel 241 into the second optical fiber 272. The thickness of each of the first and second partition walls 246, 247 is as small as possible so as to prevent scattering of the light beam therefrom.

The first and second caps 281, 282 define accommodating spaces 2811, 2821 and are formed with apertures 2812, 2822, respectively.

The first and second elastic sleeves 291, 292 are sleeved respectively on ends of the first and second optical fibers 271, 272 in a tight fitting manner and extend respectively and fittingly through the apertures 2812, 2822 in the first and second caps 281, 282 and into the accommodating spaces 2811, 2821 in the first and second caps 281, 282, respectively, thereby holding firmly the first and second optical fibers 271, 272 on the first and second caps 281, 282. In other embodiments, the liquid core waveguide assembly 2 may include a plurality of first optical fibers 271, a plurality of second optical fibers 272, a plurality of first sleeves 291 sleeved respectively on the first optical fibers 271, and a plurality of second sleeves 292 sleeved respectively on the second optical fibers 272. In some embodiments, the first and second optical fibers 271, 272 are inserted respectively into the first and second fiber channels 242, 243 in a tight fitting manner, so as to prevent undesired movement of the first and second optical fibers 271, 272 and to accurately align the first and second optical fibers 271, 272 with the waveguide channel 241 along the longitudinal direction of the waveguide channel 241.

The waveguide-forming body 20 includes first and second substrates 24, 25 bonded to each other. The first substrate 24 has a groove-forming surface 240, and is formed with a waveguide groove 241′ and first and second grooves 242′, 243′ in the groove-forming surface 240.

The second substrate 25 is bonded to the groove-forming surface 240 of the first substrate 24, and covers the waveguide groove 241′ and the first and second grooves 242′, 243′ so as to form the waveguide channel 241 and the first and second fiber channels 242, 243 in the waveguide-forming body 20, respectively. In this embodiment, the waveguide channel 241 and the first and second fiber channels 242, 243 are linear in shape, and extend along the longitudinal direction of the waveguide channel 241.

In some embodiments, the first substrate 24 is made from polydimethylsiloxane, quartz, silicon wafer, or glass, and the second substrate 25 is made from quartz, silicon wafer, or glass. In this embodiment, the first and second substrates 24, 25 are made from polydimethylsiloxane and glass, respectively.

The waveguide channel 241 is defined by a channel-defining wall that is coated with a light-confining layer 2411 of a fluoropolymer material so as to permit total internal reflection of the light beam to take place in the waveguide channel 241.

In some embodiments, a non-volatile liquid 26 is received in the first and second fiber channels 242, 243 to enclose ends of the first and second optical fibers 271, 272, respectively. The non-volatile liquid 26 has a refractive index approximate to that of the first substrate 24 so as to prevent the light beam from scattering during transmission of the light beam from the first optical fiber 271 through the first partition wall 246 into the waveguide channel 241 and from the waveguide channel 241 through the second partition wall 247 into the second optical fiber 272. In this embodiment, the non-volatile liquid 26 is silicone oil.

In this embodiment, the waveguide-forming body 20 is further formed with a bubble-trapping channel 23 disposed between and in fluid communication with the liquid inlet 248 and the waveguide channel 241. The bubble-trapping channel 23 has a plurality of linear segments 231 and a plurality of pocket segments 232 arranged alternately with and enlarged in size from the linear segments 231 so as to allow air bubbles in the liquid sample to be trapped in the pocket segments 232 before the liquid sample enters the waveguide channel 241.

The light emitting device 41 is received fittingly in the accommodating space 2811 in the first cap 281 and generates the light beam that is directed toward the first optical fiber 271. The light sensor 51 is received fittingly in the accommodating space 2821 in the second cap 282 so as to receive the light beam that passes through the waveguide channel 241 and the second optical fiber 272. In some embodiments, the light emitting device 41 is a light emitting diode, and the light sensor 51 is a photodiode.

In operation, the liquid sample is first prepared by mixing a solution containing the substance of interest, such as a nitrite-containing solution, with at least one reagent reactive to the substance, the liquid sample is subsequently injected into the waveguide channel 241 through the liquid inlet 248 and the bubble-trapping channel 23, and the light emitting device 41 is then turned on by operating the light controller 7 so as to generate the light beam which is directed to the first optical fiber 271, is transmitted through the liquid sample in the waveguide channel 241 and the second optical fiber 272, and is received by the light sensor 51. The light emitting device 41 emits an appropriate wavelength range or color of light that can be absorbed by the reaction product of the reagent and the substance in the liquid sample. The light sensor 51 generates a signal corresponding to the concentration of the substance in the solution upon receipt of the light beam. The signal thus generated is then processed by the signal processing unit 52 so as to obtain the concentration of the substance in the solution. The display 6 is coupled to the signal processing unit 52 to display the results of the concentration of the substance.

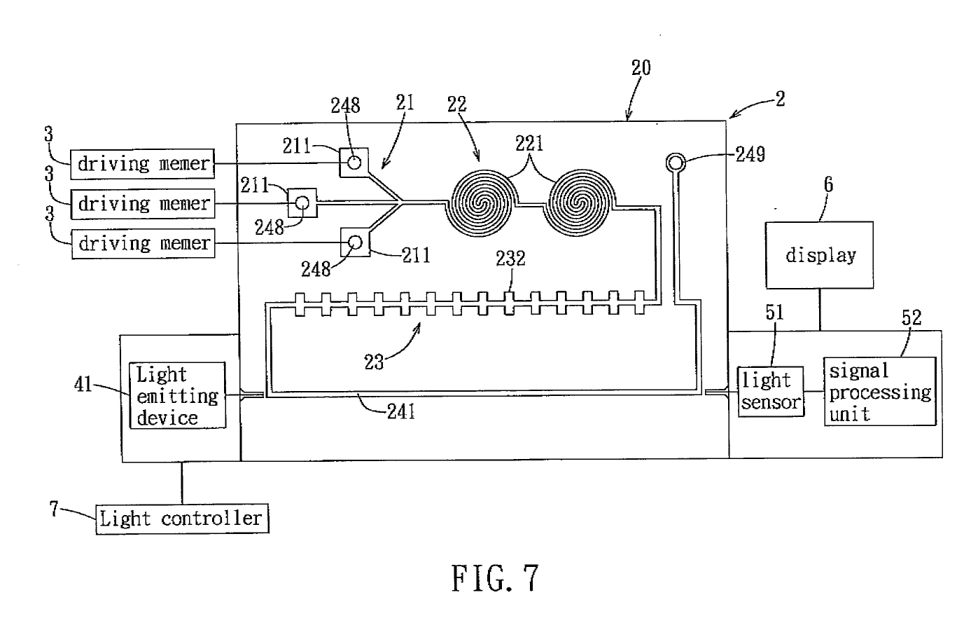

FIG. 7 illustrates another embodiment of the detecting system. This embodiment differs from the previous embodiment in that the waveguide-forming body 20 of this embodiment is further formed with a reservoir unit 21 having three reservoirs 211, three liquid inlets 248 in fluid communication with the reservoirs 211, respectively, and a fluid-mixing channel 22 disposed between and in fluid communication with the reservoir unit 21 and the bubble-trapping channel 23. In operation, a salt-containing solution and two reagents for preparing the liquid sample are injected into reservoirs 211 by three driving members 3, respectively.

In this embodiment, the fluid-mixing channel 22 includes two mixing segments 221, each of which is spiral in shape. The spiral shape of the mixing segments 221 permits thorough mixing of the salt-containing solution and the reagents to take place.

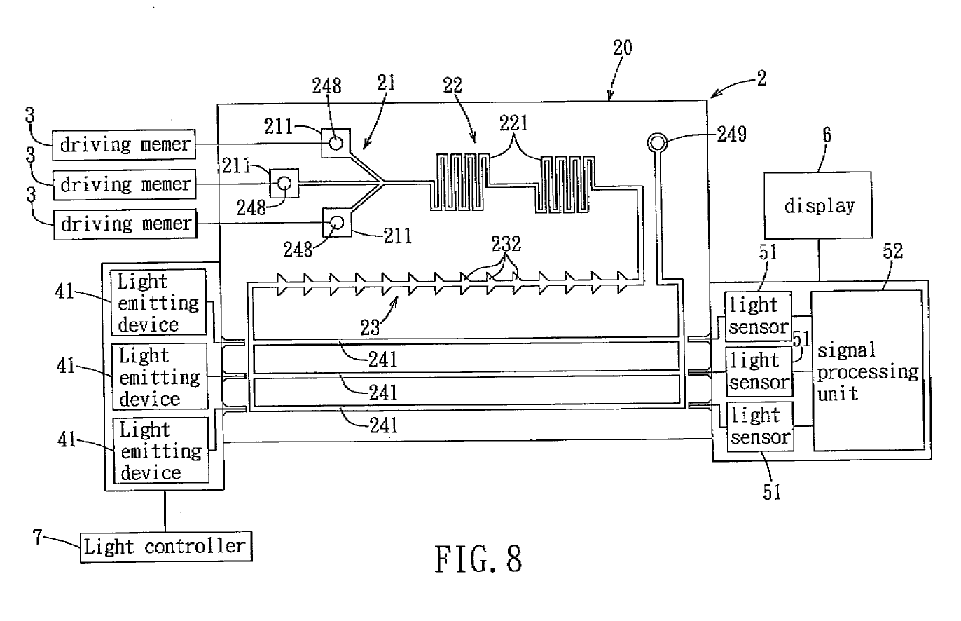

FIG. 8 illustrates yet another embodiment of the detecting system. This embodiment differs from the embodiment of FIG. 7 in that the former includes three waveguide channels 241, three light emitting devices 41 of different colors, and three light sensors 51. In addition, each of the mixing segments 221 of the fluid-mixing channel 22 is meandering in shape. As such, different liquid samples can be analyzed by using different light emitting devices 41 that emit different colors of light corresponding to the substances of interest in the liquid samples, respectively.

For instance, when a nitrite-containing solution is to be tested, one of the light emitting devices 41 that emits the green color is used to detect the concentration of the nitrite. By forming the first and second fiber channels 242, 243 in the waveguide-forming body 20 to receive fittingly and respectively the first and second optical fibers 271, 272, and by using the LED as the light emitting device 41 and the photodiode as the light sensor 51, the position-aligning working table 15 required in the aforesaid conventional detecting system can be dispensed with and the aforesaid drawbacks associated with the aforesaid conventional detecting system can be eliminated.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A liquid core waveguide assembly comprising:
a waveguide-forming body formed with at least one waveguide channel and first and second fiber channels therein and having transparent first and second partition walls and a liquid inlet in fluid communication with said waveguide channel and allowing for injection of a liquid sample into said waveguide channel therethrough, said waveguide channel having a first end disposed adjacent to said first fiber channel and spaced apart from said first fiber channel by said first partition wall, and a second end opposite to the first end, disposed adjacent to said second fiber channel, and spaced apart from said second fiber channel by said second partition wall; and
at least one first optical fiber and at lest one second optical fiber extending into said first and second fiber channels, respectively.

2. The liquid core waveguide assembly of claim 1, wherein said first and second optical fibers are inserted respectively into said first and second fiber channels in a tight fitting manner.

3. The liquid core waveguide assembly of claim 1, wherein said waveguide-forming body includes first and second substrates, said first substrate having a groove-forming surface and being formed with a waveguide groove and first and second grooves in said groove-forming surface, said second substrate being bonded to said groove-forming surface of said first substrate and covering said waveguide groove and said first and second grooves so as to form said waveguide channel and said first and second fiber channels in said waveguide-forming body.

4. The liquid core waveguide assembly of claim 3, wherein said first substrate is made from polydimethylsiloxane quartz, silicon wafer, or glass, said second substrate being made from quartz, silicon wafer, or glass, said waveguide channel being defined by a channel-defining wall that is coated with a light-confining layer of a fluoropolymer material.

5. The liquid core waveguide assembly of claim 3, further comprising a non-volatile liquid received in said first fiber channel to enclose an end of said first optical fiber, said non-volatile liquid having a refractive index approximate to that of said first substrate.

6. The liquid core waveguide assembly of claim 5, wherein said non-volatile liquid is silicone oil.

7. The liquid core waveguide assembly of claim 1, further comprising first and second caps and first and second elastic sleeves, each of said first and second caps defining an accommodating space and being formed with an aperture, said first and second elastic sleeves being sleeved respectively on ends of said first and second optical fibers in a tight fitting manner and extending respectively and fittingly through said apertures in said first and second caps.

8. The liquid core waveguide assembly of claim 1, wherein said waveguide channel and said first and second fiber channels are linear in shape and extend along a longitudinal direction of said waveguide channel.

9. The liquid core waveguide assembly of claim 1, wherein said waveguide-forming body is further formed with a bubble-trapping channel disposed between and in fluid communication with said liquid inlet and said waveguide channel, said bubble-trapping channel having a plurality of linear segments and a plurality of pocket segments arranged alternately with and enlarged in size from said linear segments.

10. The liquid core waveguide assembly of claim 9, wherein said waveguide-forming body is further formed with a mixing channel disposed between and in fluid communication with said liquid inlet and said bubble-trapping channel, said mixing channel being meandering in shape.

11. The liquid core waveguide assembly of claim 9, wherein said waveguide-forming body is further formed with a mixing channel disposed between and in fluid communication with said liquid inlet and said bubble-trapping channel, said mixing channel having a plurality of linear segments and a plurality of spiral segments that are arranged alternately with said linear segments and that are spiral in shape.

12. A detecting system for determining the concentration of a substance in a liquid, comprising: a liquid core waveguide assembly including
a waveguide-forming body formed with at least one waveguide channel and first and second fiber channels therein and having transparent first and second partition walls and a liquid inlet in fluid communication with said waveguide channel and allowing for injection of a liquid sample into said waveguide channel therethrough, said waveguide channel having a first end disposed adjacent to said first fiber channel and spaced apart from said first fiber channel by said first partition wall, and a second end opposite to said first end, disposed adjacent to said second fiber channel, and spaced apart from said second fiber channel by said second partition wall, at least one first optical fiber and at least one second optical fiber extending into said first and second fiber channels, respectively, first and second caps, each of which defines an accommodating space and is formed with an aperture, first and second elastic sleeves sleeved respectively on ends of said first and second optical fibers in a tight fitting manner and extending respectively and fittingly through said apertures in said first and second caps into said accommodating spaces in said first and second caps;
a light emitting device received fittingly in said accommodating space in said first cap for emitting a light beam into said first optical fiber; and
a light sensor received fittingly in said accommodating space in said second cap for receiving the light beam transmitted from said first optical fiber through said waveguide channel and said second optical fiber.

13. The detecting system of claim 12, wherein said light emitting device is a light emitting diode.

14. The detecting system of claim 12, wherein said light sensor is a photodiode.
